(19) United States
(12) Patent Application Publication
(10) Pub. No.: US 2005/0039356 A1
(43) Pub. Date: Feb. 24, 2005

(54) Arrangement for a combined greeting card and audio/visual component

(76) Inventor: Ron Harlick, Calgary (CA)

Correspondence Address: STURM & FIX LLP, 206 SIXTH AVENUE, SUITE 1213, DES MOINES, IA, 50309-4076, US

(21) Appl. No.: 10/645,158

(22) Filed: Aug. 21, 2003

(51) Int. Cl. G09F 1/00

(52) U.S. Cl. 40/124.06

(57) ABSTRACT

An arrangement (10) for a combined greeting card (20) having a transparent receptacle member (30) dimensioned to slidably receive an audio/visual component (40) in the form of a contoured compact disc (41) having one face provided with a first decorative image (50) wherein, a second substantially identical decorative image (50′) is visible through the transparent top sheet (33) of the receptacle member (30) and may be operatively associated with the card member (20) or the bottom sheet (32) of the receptacle member (30) whereby the two decorative images can be aligned to produce a composite whole image identical to said second decorative image (50′).

### CROSS REFERENCE TO RELATED APPLICATIONS

Not applicable.

### BACKGROUND OF THE INVENTION

1. Field of the Invention

The present invention relates to the field of greeting cards combined with audio components in general and in particular to a unique interaction between the greeting card and the audio component.

2. Description of Related Art

As can be seen by reference to the following U.S. Pat. Nos. 5,738,221; 4,566,590; 4,829,105; 5,915,734, the prior art is replete with myriad and diverse greeting card and audio component combinations.

While all of the aforementioned prior art constructions are more than adequate for the basic purpose and function for which they have been specifically designed, they are uniformly deficient with respect to their failure to provide a simple, efficient, and practical unique interaction between the greeting card and audio component that results in a totally unexpected visual image.

Unfortunately, virtually all of the prior art constructions merely provide a transparent storage receptacle on a selected card surface so that the audio or visual component is clearly visible to the recipient and nothing more.

However, given the aggressive marketing pursued by most greeting card companies, it is surprising that to date they have not thought of a more dramatic way to draw the recipient's attention in an aesthetically pleasing manner to the audio component.

As a consequence of the foregoing situation, there has existed a longstanding need for a new and improved method or arrangement for storing an audio component on a greeting card so that the audio component interacts with the storage receptacle in a totally new and unique fashion; and, the provision of such an arrangement is the stated objective of the present invention.

### BRIEF SUMMARY OF THE INVENTION

Briefly stated, the arrangement that forms the basis of the present invention comprises in general a conventional greeting card member, a transparent receptacle member affixed to one of the faces of the greeting card member, a miniature contoured compact disc containing audio and/or visual data, and a pair of identical decorative images operatively associated with both the transparent receptacle or the greeting card member and one face of the compact disc.

As will be explained in greater detail further on in the specification, the primary purpose of this invention is to provide a unique interaction between a pair of substantially identical decorative images wherein one of the images is imprinted on a label that has a portion removed from the space occupied by the central aperture in the disc member to which the label is applied, and the other decorative image is visible through the transparent top sheet of the transparent receptacle member; such that when the disc member is properly aligned within the receptacle member, the missing portion of the decorative image on the disc member will be visually duplicated by the companion portion of the missing decorative image that is visible through the central aperture in the disc member and the top sheet of the receptacle member.

In addition, the unaltered decorative image may be imprinted either directly on the face of the card member positioned beneath the transparent receptacle member, or in the alternative, be imprinted on a label affixed to the inner sheet of the transparent receptacle member.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a rear perspective view of a conventional greeting card modified in accordance with the teachings of this invention;

FIG. 2 is an isolated detail view of the compact disc partially inserted into the storage receptacle; and,

FIG. 3 is an isolated detail view of the compact disc properly aligned within the storage receptacle to align the images printed on the decorative labels;

FIG. 4 is an isolated detail view of a variety of proposed compact disc configurations.

### DETAILED DESCRIPTION OF THE INVENTION

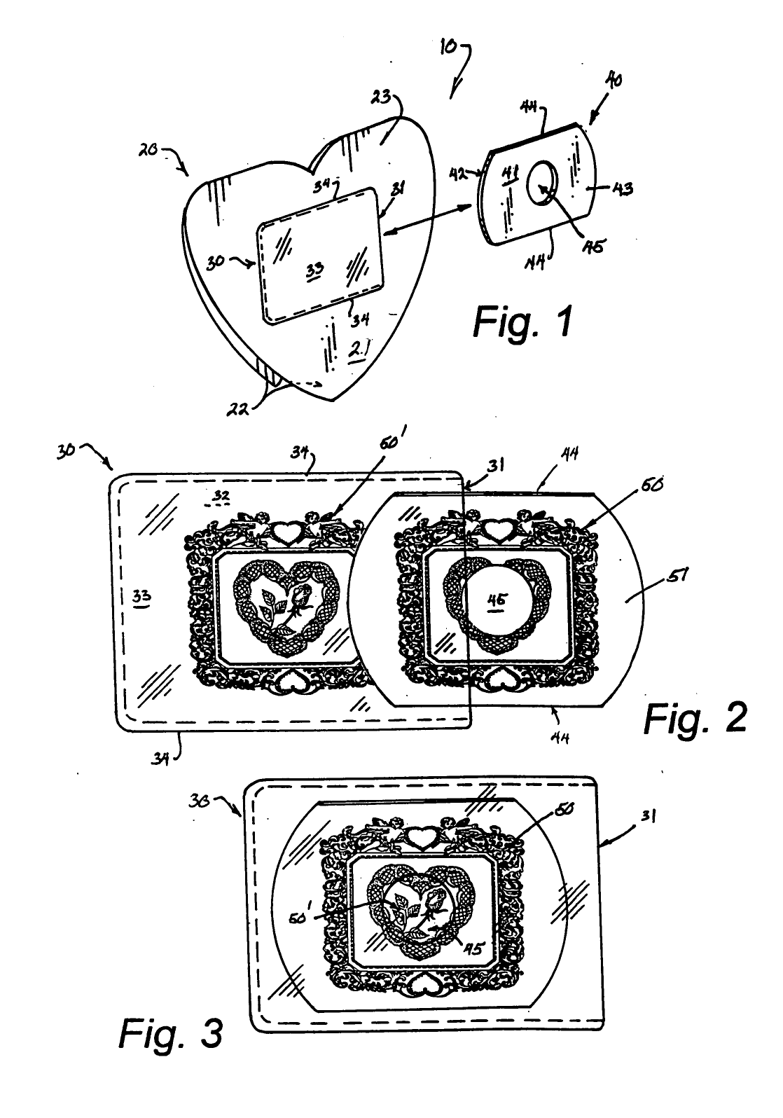

As can be seen by reference to the drawings, and in particular to FIG. 1, the arrangement that forms the basis of the present invention is designated generally by the reference number 10. The arrangement 10 includes a conventional greeting card member 20 fabricated from folded card stock 21 and having a plurality of interior 22 and exterior 23 faces.

As shown in FIGS. 1 and 2, the arrangement 10 further includes a transparent storage receptacle 30 having an open end 31 formed when two generally rectangular inner 32 and outer 33 sheets of clear plastic have their opposed edges joined together on three of their four sides.

Still referring to FIGS. 1 and 2, it can be seen that the audio and/or visual component 40 of this invention comprises a miniature compact disc 41 having a data bearing face 42 and a blank face 43 the purpose and function of which will be explained in greater detail further on in the specification.

In addition, in the preferred embodiment of this invention illustrated in the drawings, the compact disc 41 is further provided with a pair of parallel straight edges 44 44 which are alignable with the opposed sealed edges 34 34 on the transparent storage receptacle 30 for reasons that will be explained presently.

Turning now to FIGS. 2 and 3, it can be seen that final pieces of the arrangement 10 includes a pair of substantially identical decorative images 50 50′; wherein, at least one of the decorative images 50 is printed on a label 51 that is affixed to the blank face 43 of the compact disc 41; and wherein, the other decorative image 50′ may either be imprinted on another label 51 affixed on the inner clear plastic sheet 32 of the storage receptacle 30 or in the alternative, the second decorative image 50′ may be imprinted directly on the same face 23 of the greeting card 20 containing the transparent storage receptacle 30.

As can best be appreciated by reference to FIGS. 2 and 3, the heart of this invention revolves around the fact that the decorative images 50 50′ are alignable with one another in an overlapping arrangement to provide the illusion that the compact disc 41 does not have an enlarged central aperture 45 as well as camouflaging the presence of the compact disc 41 on the greeting card 20.

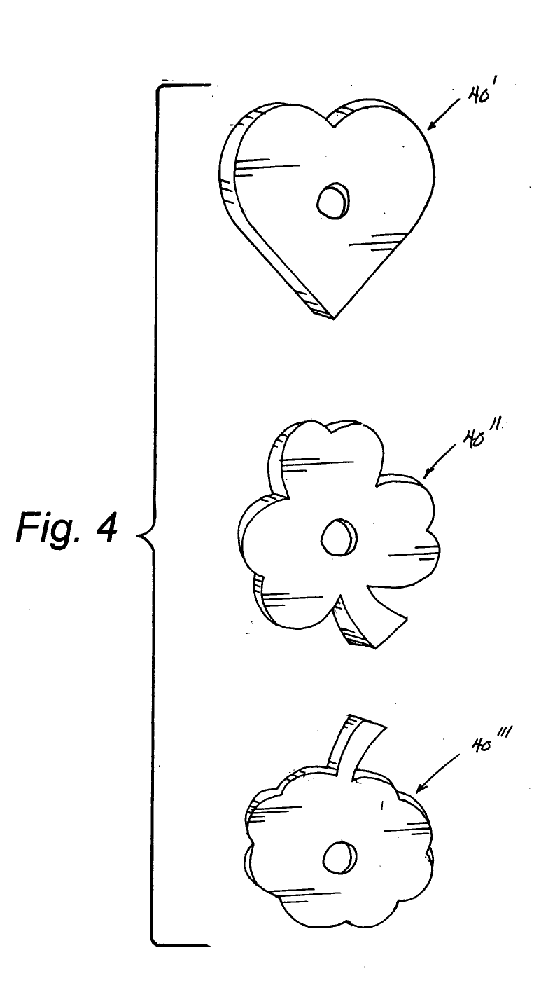

Furthermore, in an alternate version of the preferred embodiment depicted in FIG. 4, it can be seen that this invention further contemplates the use of non-uniform compact disc configurations such as a heart, shamrock, pumpkin, etc.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. An arrangement for a combined greeting card and an audio/visual component wherein the arrangement comprises
a conventional greeting card member having a plurality of faces
a transparent receptacle member affixed to one of said plurality of faces on the greeting card and having an opening providing access to the interior of the receptacle member; and,
an audio/visual component including a compact disc dimensioned to be slidably received in the opening in the transparent receptacle member.

2. The arrangement as in claim 1; wherein, said compact disc has a non-uniform periphery that limits the access of the compact disc relative to the transparent receptacle member.

3. The arrangement as in claim 1; wherein, the transparent receptacle member includes an inner sheet and an outer sheet of material having a plurality of opposed edges joined together to form the receptacle member.

4. The arrangement as in claim 2; wherein, the transparent receptacle member includes an inner sheet and an outer sheet of material having a plurality of opposed edges joined together to form the receptacle member.

5. The arrangement as in claim 3; wherein, at least the outer sheet of material is transparent.

6. The arrangement as in claim 4; wherein, at least the outer sheet of material is transparent.

7. The arrangement as in claim 3; wherein, both the inner and outer sheets of material are transparent.

8. The arrangement as in claim 4; wherein, both the inner and outer sheets of material are transparent.

9. The arrangement as in claim 1 further comprising a pair of substantially identical decorative images wherein one of the decorative images is operatively associated with one of the faces of the compact disc and the other of the decorative images is operatively associated with a selected one of the receptacle member and the card member.

10. The arrangement as in claim 2; further comprising a pair of substantially identical decorative images wherein one of the decorative images is operatively associated with one of the faces of the compact disc and the other of the decorative images is operatively associated with a selected one of the receptacle member and the card member.

11. The arrangement as in claim 3; further comprising a pair of substantially identical decorative images wherein one of the decorative images is operatively associated with one of the faces of the compact disc and the other of the decorative images is operatively associated with a selected one of the receptacle member and the card member.

12. The arrangement as in claim 4; further comprising a pair of substantially identical decorative images wherein one of the decorative images is operatively associated with one of the faces of the compact disc and the other of the decorative images is operatively associated with a selected one of the receptacle member and the card member.

13. The arrangement as in claim 7; further comprising a pair of substantially identical decorative images wherein one of the decorative images is operatively associated with one of the faces of the compact disc and the other of the decorative images is operatively associated with a selected one of the receptacle member and the card member.

14. The arrangement as in claim 8; further comprising a pair of substantially identical decorative images wherein one of the decorative images is operatively associated with one of the faces of the compact disc and the other of the decorative images is operatively associated with a selected one of the receptacle member and the card member.

15. The arrangement as in claim 9; wherein, said compact disc has a pair of parallel straight edges that are dimensioned to closely conform to the interior of the receptacle.

16. The arrangement as in claim 14; wherein, said compact disc has a pair of parallel straight edges that are dimensioned to closely conform to the interior of the receptacle.
